(19) United States
(12) Patent Application Publication
(10) Pub. No.: US 2026/0212629 A1
(43) Pub. Date: Jul. 23, 2026

(54) INFORMATION PROCESSING DEVICE, INFORMATION PROCESSING SYSTEM, AND INFORMATION PROCESSING METHOD

(71) Applicant: Mitsubishi Electric Corporation, Tokyo (JP)

(72) Inventors: Misato NAITO, Tokyo (JP); Susumu IINO, Tokyo (JP)

(73) Assignee: Mitsubishi Electric Corporation, Tokyo (JP)

(21) Appl. No.: 19/140,384

(22) PCT Filed: Feb. 1, 2023
(86) PCT No.: PCT/JP2023/003183

§ 371 Date: Jun. 18, 2025

(51) Int. Cl. G06V 10/25; G06V 10/60

(52) U.S. Cl. CPC G06V 10/25; G06V 10/60; G06V 2201/07

(57) ABSTRACT

An information processing device includes an estimation unit that detects an object from an image represented by image data by using an estimation model and estimates object-related information that is information related to the object and a scene information selection unit that selects object-related information that satisfies a selection condition, from the estimated object-related information, as at least part of scene information.

### TECHNICAL FIELD

This disclosure relates to information processing devices, programs, information processing systems, and information processing methods.

### BACKGROUND ART

In recent years, progress has been made in applying artificial intelligence (AI) to surveillance systems that use surveillance cameras. In general, to improve the accuracy of AI models (e.g., object detection AI models) installed in surveillance systems, a good way to learn is to use image data recorded at the location where the surveillance camera is installed.

For example, Patent Document 1 discloses a method for easily generating learning data by creating a composite image by superimposing an image of an object on a background image.

### PRIOR ART REFERENCE

### Patent Reference

Patent Document 1: JP 2020-149086 A

### SUMMARY OF INVENTION

### Problem to be Solved by the Invention

However, issues of privacy and the right of a subject captured in the image by the camera make it difficult to use the image for AI learning without the subject's consent. One possible method is to remove the parts of the image that correspond to privacy information by masking the entire body or face region of the subject, but this method may remove important information for AI learning data.

Therefore, an objective of one or more aspects of the present disclosure is to enable the identification of desired features as learning data without using the privacy information of the subject.

### Means of Solving the Problem

An information processing device according to one aspect of the present disclosure includes: an estimation unit to detect an object from an image represented by image data by using an estimation model and to estimate object-related information that is information related to the object; and a scene information selection unit to select object-related information that satisfies a selection condition, from the estimated object-related information, as at least part of scene information.

A program according to one aspect of the present disclosure causes a computer to function as: an estimation unit to detect an object from an image represented by image data by using an estimation model and to estimate object-related information that is information related to the object; and a scene information selection unit that selects object-related information that satisfies a selection condition, from the estimated object-related information, as at least part of scene information.

An information processing system according to one aspect of the present disclosure includes: an estimation unit to detect an object from an image represented by image data by using an estimation model and to estimate object-related information that is information related to the object; and a scene information selection unit that selects object-related information that satisfies a selection condition, from the estimated object-related information, as at least part of scene information.

An information processing method according to one aspect of the present disclosure includes: detecting an object from an image represented by image data by using an estimation model and estimating object-related information that is information related to the object; and selecting object-related information that satisfies a selection condition, from the estimated object-related information, as at least part of scene information.

### Effects of the Invention

According to one or more aspects of the present disclosure, it is possible to identify desired features as learning data without using privacy information of the subject.

### BRIEF DESCRIPTION OF DRAWINGS

FIG. 1 is a block diagram schematically illustrating the configuration of an information processing device according to Embodiment 1.

FIG. 2 is a schematic diagram illustrating an example of an image captured by an image-capturing unit.

FIG. 3 is a schematic diagram illustrating an example of an estimation result.

FIG. 4 is a schematic diagram illustrating an example of scene information.

FIGS. 5A and 5B are schematic diagrams illustrating examples of superimposing the scene information illustrated in FIG. 4 on a background image.

FIGS. 6A and 6B are schematic diagrams illustrating examples of first learning data.

FIGS. 7A and 7B are schematic diagrams illustrating examples of the displayed images.

FIG. 8 is a schematic diagram illustrating an example of the check scene information.

FIG. 9 is a block diagram schematically illustrating the configuration of information processing devices according to Embodiments 2 and 3.

FIG. 10 is a block diagram schematically illustrating the configuration of a learning unit.

FIG. 11 is a block diagram schematically illustrating the configuration of a computer.

### MODE FOR CARRYING OUT THE INVENTION

### Embodiment 1

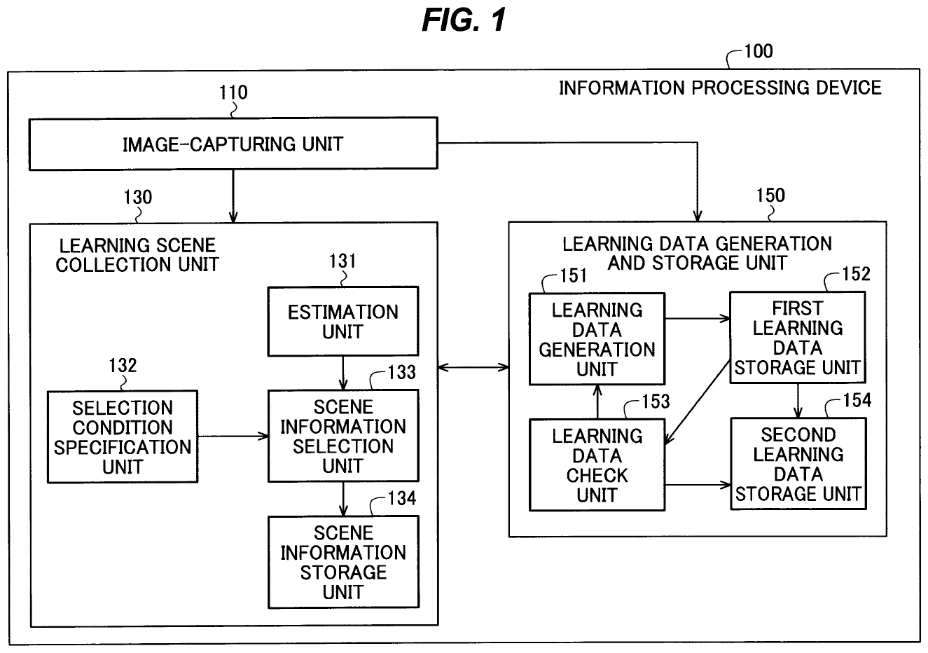

FIG. 1 is a block diagram schematically illustrating the configuration of an information processing device 100 according to Embodiment 1.

The information processing device 100 includes an image-capturing unit 110, a learning scene collection unit 130, and a learning data generation and storage unit 150.

The image-capturing unit 110 captures an image that includes the object to be learned and generates image data that indicates that image. The generated image data is provided to the learning scene collection unit 130.

The learning scene collection unit 130 uses the image data from the image-capturing unit 110 as input data and uses an estimation model to make estimations and generate scene information that is used as the basis for generating learning data.

The learning scene collection unit 130 includes an estimation unit 131, a selection condition specification unit 132, a scene information selection unit 133, and a scene information storage unit 134.

The estimation unit 131 detects an object from the image represented by image data from the image-capturing unit 110 by using an estimation model to estimate object-related information, which is information related to the object. The estimated object-related information is provided to the scene information selection unit 133 as the estimation result. Here, the object-related information is assumed to include the position information, the class name, and the confidence level of the estimated object. The class name is, e.g., type identification information that indicates the type of the object. Here, the class name is assumed to be the object name, that is, the name of the object. The confidence level is an indicator that indicates the correct probability of the estimation result and is assumed to be greater than or equal to 0 and less than or equal to 1, for example.

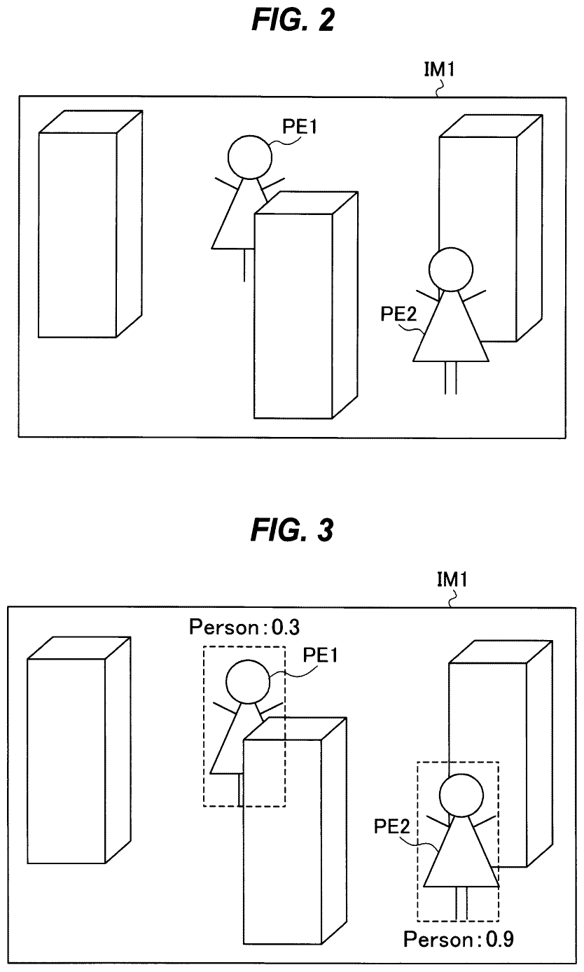

FIG. 2 is a schematic diagram illustrating an example of an image captured by the image-capturing unit 110. As illustrated in FIG. 2, there are persons PE1 and PE2 in an image IM1.

From the image data of such an image, the estimation unit 131 is assumed to estimate the position information, the class name, and the confidence level of each of the persons PE1 and PE2, as illustrated in FIG. 3.

For example, when the position information is expressed as the (x-coordinate of the upper left, y-coordinate of the upper left, width, height) of the rectangle enclosing the object, the position information, the class name, and the confidence level of the person PE1 can be expressed as (700, 100, 200, 900), “Person”, and “0.3”, respectively. In addition, the position information, the class name, and the confidence level of the person PE2 can be expressed as (1500, 800, 300, 1000), “Person”, and “0.9”, respectively.

To return to FIG. 1, the selection condition specification unit 132 specifies the selection condition to be selected as scene information from the estimation results of the estimation unit 131. The selection condition can be, e.g., a condition for performing the selection by at least one of the position, the class name, and the confidence level.

For example, if it is required to collect scenes with low confidence as determined by the estimation by the estimation unit 131, the estimation results with a confidence level below a predetermined threshold (e.g. 0.6) may be selected as the scene information. In this case, the selection condition is that the confidence level is below the predetermined threshold.

Furthermore, if, for example, it is necessary to collect scenes of locations through which objects frequently pass as learning data, the estimation results with position information indicating the locations to be collected may be selected as scene information. In this case, the selection condition is that the position information is within a predetermined range.

The scene information selection unit 133 selects, out of the estimation results of the estimation unit 131, the estimation results that satisfy the selection condition specified by the selection condition specification unit 132 as at least part of the scene information. The scene information selection unit 133 then provides the selected scene information to the scene information storage unit 134.

The scene information storage unit 134 stores the received scene information.

Here, the scene information is information that does not include privacy information and is used as a basis for generating the learning data.

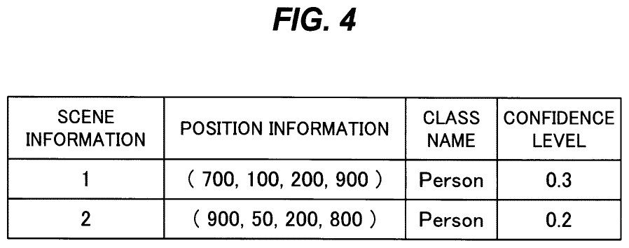

FIG. 4 is a schematic diagram illustrating an example of scene information.

The information that is used as a basis for generating learning data may include, e.g., the position information, the class name, and the confidence level that are the results of the estimation by the estimation unit 131. In addition, scene information may also include other information that does not correspond to privacy information, such as the hue of an object, the time at which the image represented by the image data was captured, or the illuminance of the image represented by the image data.

Even when the estimation unit 131 uses an estimation model other than the object detection model, the scene information may include information that does not correspond to privacy information out of the estimation results.

For example, as the information that does not correspond to privacy information, the hue of an object may be obtained from position information. Specifically, by obtaining a histogram of pixel values near the center of the detection frame that specifies a person and his or her position information as an object, the approximate color of their clothing, or in other words, the hue of the object, can be determined. In other words, the position information of the object can be associated with hue information. The detection frame used here is a means for identifying the detection position described above. In other cases, when it is possible to use an estimation model to estimate age, gender, posture, or the like, this information can be used as scene information within the range that does not correspond to privacy information.

As described above, it is possible to acquire scene information that indicates the desired features as learning data without using the privacy information of the subject.

To return to FIG. 1, the learning data generation and storage unit 150 generates learning data according to the scene information collected by the learning scene collection unit 130. The learning data generation and storage unit 150 stores the generated learning data.

The learning data generation and storage unit 150 includes a learning data generation unit 151, a first learning data storage unit 152, a learning data check unit 153, and a second learning data storage unit 154.

The learning data generation unit 151 acquires scene information from the scene information storage unit 134 and generates image data representing a new image as learning data according to the scene information. The learning data generated here is referred to as the first learning data. The first learning data is stored in the first learning data storage unit 152. The new image here is an image that is different from the image represented by the image data used when the learning scene collection unit 130 has collected scene information.

The learning data generation unit 151 executes processing when the scene information storage unit 134 has accumulated a certain amount of scene information or when a certain period of time has elapsed. Alternatively, the learning data generation unit 151 may execute processing when instructed to start the processing from the outside. The learning data may be updated whenever scene information is generated.

For example, the learning data generation unit 151 acquires the scene information stored in the scene information storage unit 134 and uses objects that do not present privacy issues to generate the first learning data based on the scene information. Here, the first learning data is assumed to be associated in an identifiable way with the scene information that was used as the basis for generating the first learning data.

The object that does not present privacy issue may be an image of an object such as a person who has consented to be the subject of the learning data or an image of an object such as a person that does not contain privacy information.

The following will explain the generation of the first learning data in the learning data generation unit 151 with reference to the figures.

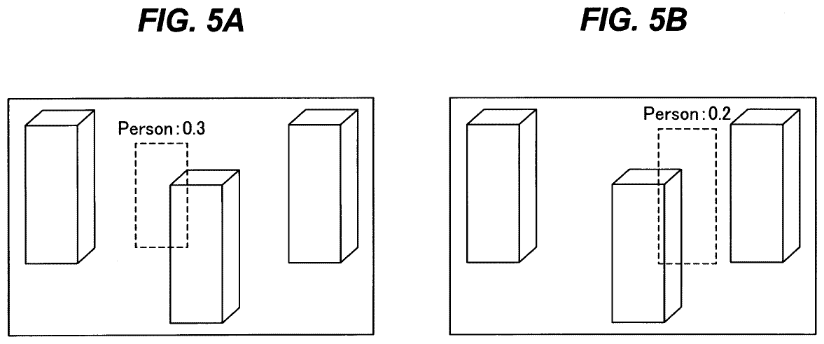

FIGS. 5A and 5B are schematic diagrams illustrating an example of superimposing the scene information illustrated in FIG. 4 on a background image.

As illustrated in FIG. 5A, the first scene information in the scene information illustrated in FIG. 4 includes position information (700, 100, 200, 900), class name “Person,” and confidence level “0.3”. In FIG. 5A, the class name and the confidence level are indicated in a dashed rectangle at the position indicated by the position information.

As illustrated in FIG. 5B, the second scene information in the scene information illustrated in FIG. 4 includes position information (900, 50, 200, 800), class name “Person” and confidence level “0.2”. In FIG. 5B, the class name and the confidence level are indicated in a dashed rectangle at the position indicated by the position information.

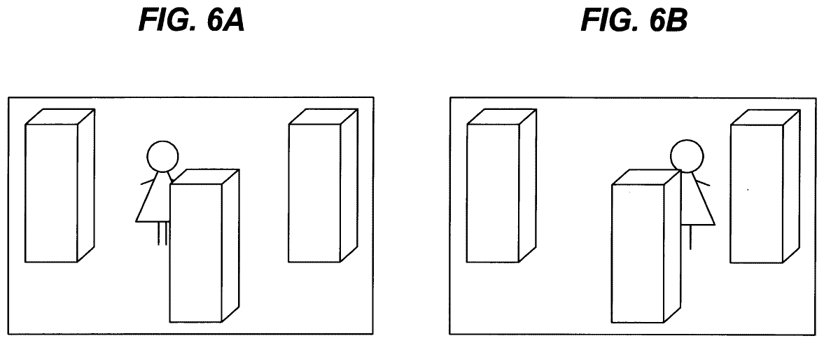

The learning data generation unit 151 generates the first learning data as illustrated in FIGS. 6A and 6B by placing objects that do not present privacy issues at the positions indicated by the dashed rectangles in the examples illustrated in FIGS. 5A and 5B.

Although a single first learning data is generated for a single scene information illustrated in FIG. 6, it is also possible to generate multiple first learning data for a single scene information. Conversely, one first learning data may include multiple scene information.

Here, the background image is assumed to be, e.g., one captured by the image-capturing unit 110.

The object that does not present a privacy issue may be generated by using, e.g., a well-known technology that uses computer graphics (CG) or AI. If the scene information includes the date and time or illuminance, the effects of these factors may be reflected in the objects that do not present privacy issues.

If computer graphics are used, the user may manually superimpose the object that does not present a privacy issue by using computer graphics. In this case, the learning data generation unit 151 may instruct the user as to which object should be superimposed at which position in the background image based on the scene information.

In addition, the learning data generation unit 151 may not use the image captured at the position where the image for which the scene information has been acquired has been captured as the background image but may use an image similar to the image captured at the position where the image for which the scene information has been acquired has been captured. For example, the learning data generation unit 151 may use an image generated by the user to imitate the background by using computer graphics as the background image.

In the above example, the learning data generation unit 151 generates the first learning data by placing an object that does not present a privacy issue in the background image according to the scene information, but the first learning data may also be generated by capturing an image of a person who has consented to use their image as learning data with the image-capturing unit 110.

For example, the learning data generation unit 151 may cause a display unit not illustrated in the figure to display an example of a new image to be captured according to the scene information and generate the first learning data by using an image of an object that does not present a privacy issue according to that example. In the following, the subject is assumed to be a person who has consented to use their photograph as learning data.

The learning data generation unit 151 acquires scene information from the scene information storage unit 134, and based on the scene information, indicates on a display unit not illustrated in the figure what kind of scene image is required for the subject. Specifically, the learning data generation unit 151 may indicate the subject by using an image or may indicate the subject by using a text phrase such as “Person at coordinates (700, 100, 200, 900)”.

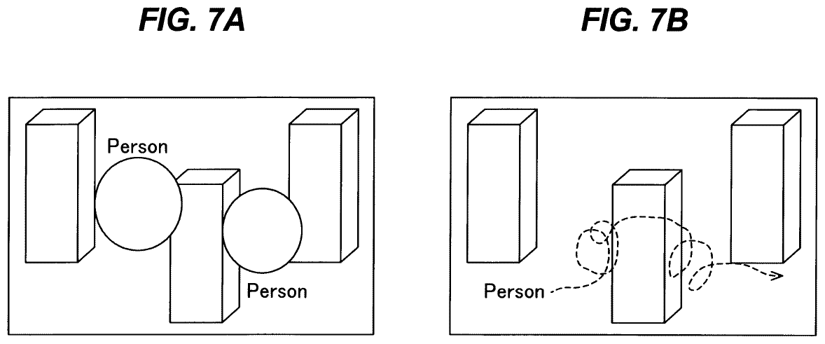

In addition, when scene information such as that illustrated in FIG. 4 has been acquired, the learning data generation unit 151 may indicate what kind of scene image is required for the subject by displaying an image such as that illustrated in FIG. 7A or FIG. 7B on a display unit not illustrated in the figure.

In FIG. 7A, a position where an image of a person is required is indicated by a circle. Based on this image, the subject moves around the specified position and its surroundings, and the image-capturing unit 110 captures an image of the subject in that state, thereby generating the first learning data.

In addition, in FIG. 7B, the route that the subject should move along is indicated. In this case, as information for the moving direction of the person to move along the route, e.g., front, back or side, or angle or orientation, may be added. The route is created so that it passes through the position indicated by the position information of the acquired scene information. The first learning data is generated by the subject moving along the specified route and the image-capturing unit 110 capturing the subject in that state. Here, it is also possible to reduce the capturing time by indicating the shortest route.

In addition, if the scene information includes color, posture, or the like, the learning data generation unit 151 may cause the display unit not illustrated in the figure to display that information.

To return to FIG. 1, the first learning data storage unit 152 stores the first learning data generated by the learning data generation unit 151.

The learning data check unit 153 checks whether the first learning data stored in the first learning data storage unit 152 is desirable data as learning data. For example, if the first learning data satisfies the predetermined conditions, the learning data check unit 153 determines that such first learning data is desirable learning data and stores such first learning data as second learning data in the second learning data storage unit 154. On the other hand, if the first learning data does not satisfy the predetermined conditions, the learning data check unit 153 communicates the scene information that was used as the basis for generating the first learning data to the learning data generation unit 151 and instructs the generation of the first learning data again. Here, the predetermined condition is, e.g., to satisfy the selection condition specified by the selection condition specification unit 132, as described below.

Specifically, the learning data check unit 153 acquires the first learning data and provides the first learning data to the estimation unit 131 of the learning scene collection unit 130.

The estimation unit 131 performs an estimation on the first learning data and provides the estimation result to the learning data check unit 153. The estimation results obtained in this way are referred to as the check scene information.

When the check scene information is received, the learning data check unit 153 checks whether the selection condition specified by the selection condition specification unit 132 is satisfied. Furthermore, the learning data check unit 153 may also check whether the check scene information that satisfies the selection condition specified by the selection condition specification unit 132 is close to the scene information that was used as the basis for generating the first learning data.

In this embodiment, the closeness of the scene information is determined by comparing the position information, the class name, and the confidence level.

The closeness of the position information can be determined by checking whether the intersection over union (IoU) value, which indicates the degree of overlap of the position information, is greater than a predetermined threshold value. Alternatively, the closeness of the position information may be determined by checking whether the difference between the central coordinates or the coordinates of the four corners of both position information is less than a predetermined threshold value. The above threshold values shall be set in advance for each device.

The closeness of the confidence level may be determined by checking whether the difference between the confidence level of the check scene information and the confidence level specified as the selection condition in the selection condition specification unit 132 is less than a predetermined threshold value.

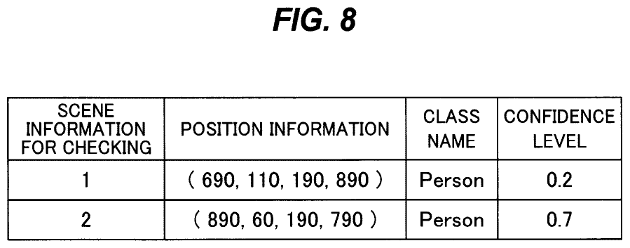

Here, an example will be explained in which the check scene information illustrated in FIG. 8 is obtained for the first learning data illustrated in FIGS. 6A and 6B.

In this embodiment, explained is a case of checking whether the selection condition specified by the selection condition specification unit 132 is satisfied, and also checking whether the position information and the class name of the check scene information are close to those of the original scene information.

In this case, since the selection condition specified by the selection condition specification unit 132 is “confidence level of 0.6 or less”, the confidence level “0.2” of the first check scene information satisfies the selection condition, but the confidence level “0.7” of the second check scene information does not satisfy the selection condition.

The learning data check unit 153 compares the scene information illustrated in FIG. 4 with the check scene information illustrated in FIG. 8.

It is assumed that the position information is determined to be close because the IoU value is above the threshold. In addition, the class name is the same because it is “Person” for both.

From the above, the first learning data illustrated in FIG. 6A is desirable data as learning data, but the first learning data illustrated in FIG. 6B is not desirable data as learning data.

For this reason, the learning data check unit 153 stores the first learning data corresponding to the first scene information illustrated in FIG. 6A in the second learning data storage unit 154 as the second learning data. The second data is data that is used as the input data for the teacher data used to train the learning model.

As another example, a case will be explained in which the class name is specified as “Person” and the hue is specified as “Black” as the selection condition. Here, it is assumed that the learning data check unit 153 only checks whether the selection condition is satisfied.

In this case, the learning data check unit 153 checks whether the class name and the hue of the check scene information satisfy the selection condition. If they satisfy the selection condition, the learning data check unit 153 determines that the first learning data of the target is desirable data as learning data without checking whether the check scene information is close to the original scene information.

Next, the learning data check unit 153 notifies the learning data generation unit 151 of the identification information for identifying the second scene information corresponding to the first learning data illustrated in FIG. 6B, thereby instructing the learning data generation unit 151 to generate the first learning data corresponding to this second scene information again.

Upon receiving instructions from the learning data check unit 153, the learning data generation unit 151 generates the first learning data corresponding to the indicated second scene information again. The first learning data that is generated again is provided to the learning data check unit 153. The first learning data that is generated again is also referred to as the regenerated learning data or the first regenerated learning data.

The learning data check unit 153 checks again the first regenerated learning data that has been regenerated by the learning data generation unit 151. If it is determined that the first regenerated learning data satisfies the condition, it is stored in the second learning data storage unit 154 as the second learning data. If it is determined that the condition is not satisfied again, the learning data check unit 153 will either issue instructions to the learning data generation unit 151 again or terminate the process.

The times for the learning data check unit 153 to instruct the regeneration may be set in advance. Alternatively, the user may instruct the learning data generation unit 151 to stop the regeneration by using an input unit not illustrated.

The following is an example of the learning data generation unit 151 preparing N types of human images as objects that do not present privacy issues. In this case, it is possible to generate the first set of learning data by randomly selecting one of the images and superimposing it on a background image based on scene information.

If the learning data check unit 153 determines that the first learning data generated in this way does not satisfy the condition, the learning data generation unit 151 randomly selects another one of the N types of person images and generates the first learning data again.

In this kind of processing, the learning data check unit 153 can give instructions to regenerate up to N-1 times. In addition, to prevent processing time from becoming too long, the maximum number of times to instruct the regeneration may be set in advance.

In the above example, the learning data generation unit 151 may first generate N types of first learning data from scene information by using N types of person images. Then, among the N types of first learning data, all of the data that are determined by the learning data check unit 153 to satisfy the conditions may be stored in the second learning data storage unit 154 as second learning data. In such a case, the learning data check unit 153 does not need to issue a regeneration instruction.

In addition to the above example, when the learning data generation unit 151 is instructed to perform the regeneration, it may regenerate N types of first learning data by randomly shifting the position or size indicated by the scene information and superimposing objects that do not present privacy issues on the background image. In such a case, the learning data check unit 153 will instruct the regeneration until N types of first learning data are generated.

As described above, when it is determined that the learning data is not desirable data, the learning data generation unit 151 generates regenerated learning data that indicates an image different from the image represented by the learning data according to the scene information, and the learning data check unit 153 checks whether the regenerated learning data is desirable data or not and sets the desirable learning data as the second learning data, thereby reducing the possibility that there is no second learning data corresponding to each scene information.

The second learning data storage unit 154 stores the first learning data that is determined to satisfy the condition by the learning data check unit 153 as the second learning data.

As a result of the above, the second learning data, which is the image that is desired as learning data, can be obtained without using privacy information.

### Embodiment 2

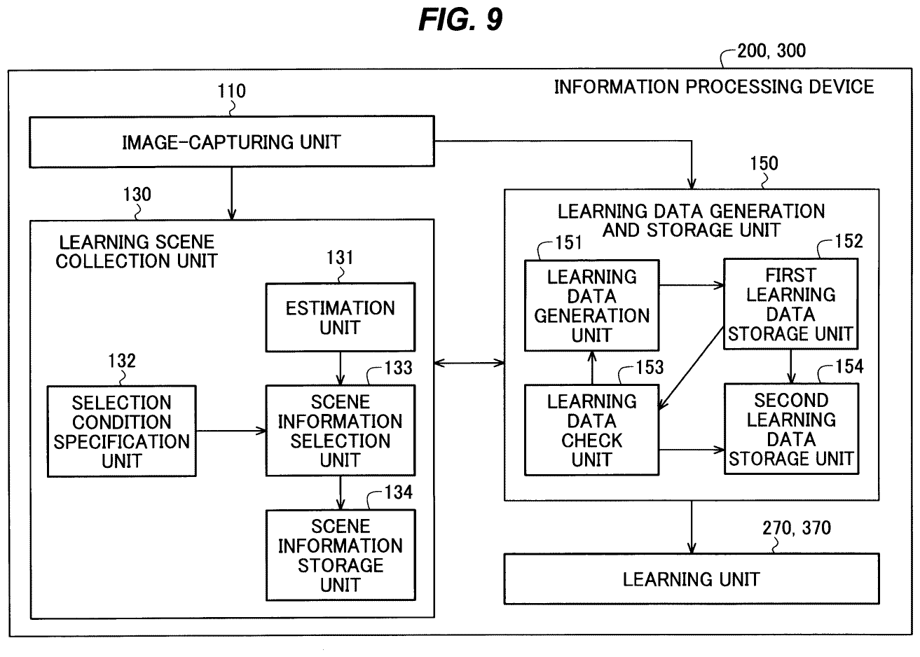

FIG. 9 is a block diagram schematically illustrating the configuration of the information processing device 200 according to Embodiment 2.

The information processing device 200 of Embodiment 2 trains the learning model by using the second learning data generated in the same way as the information processing device 100 of Embodiment 1.

The information processing device 200 includes an image-capturing unit 110, a learning scene collection unit 130, a learning data generation and storage unit 150, and a learning unit 270.

The image-capturing unit 110, the learning scene collection unit 130, and the learning data generation and storage unit 150 of the information processing device 200 of Embodiment 2 are the same as the image-capturing unit 110, the learning scene collection unit 130, and the learning data generation and storage unit 150 of the information processing device 100 of Embodiment 1.

The learning unit 270 acquires the second learning data from the second learning data storage unit 154 of the learning data generation and storage unit 150.

The learning unit 270 then generates teacher data by using the second learning data as the input data and uses this teacher data to train the learning model.

Generally, as teacher data for training an AI learning model, it is necessary to prepare image data and annotation data that indicate the corresponding correct answers as the correct answer label.

As the second learning data is image data, it is necessary to create annotation data.

Annotation data is usually added manually. Thus, the learning unit 270 can acquire the annotation data indicating the correct answers from the user by using a graphical user interface (GUI) via a display unit and input unit that are not illustrated in the figure.

The learning data generation unit 151 then trains the learning model by using the teacher data.

As described above, according to Embodiment 2, the learning model can be trained by using the collected second learning data.

### Embodiment 3

As illustrated in FIG. 9, the information processing device 300 of Embodiment 3 includes an image-capturing unit 110, a learning scene collection unit 130, a learning data generation and storage unit 150, and a learning unit 370.

In Embodiment 2, an example of acquiring annotation data from a user is described; on the other hand, in Embodiment 3, an example of automatically attaching annotation data by using a high-precision AI model will be described. A high-precision AI model is a trained AI model that can be used as a means to achieve the target accuracy of the learning model used in this disclosure, such as an AI model that achieves the desired level of accuracy in estimating the target to be detected under the assumed imaging conditions even when the AI model operates on a computer capable of performing more advanced computations than edge devices such as cameras, or when the AI model operates on edge devices with similar processing power.

The image-capturing unit 110, the learning scene collection unit 130, and the learning data generation and storage unit 150 of the information processing device 300 of Embodiment 3 are the same as the image-capturing unit 110, the learning scene collection unit 130, and the learning data generation and storage unit 150 of the information processing device 100 of Embodiment 1.

The learning unit 370 acquires the second learning data from the second learning data storage unit 154 of the learning data generation and storage unit 150.

The learning unit 370 then generates teacher data by using the second learning data as the input data and uses this teacher data to train the learning model. For example, the learning unit 370 uses the teacher data generated by attaching correct answer labels to the input data to train the learning model.

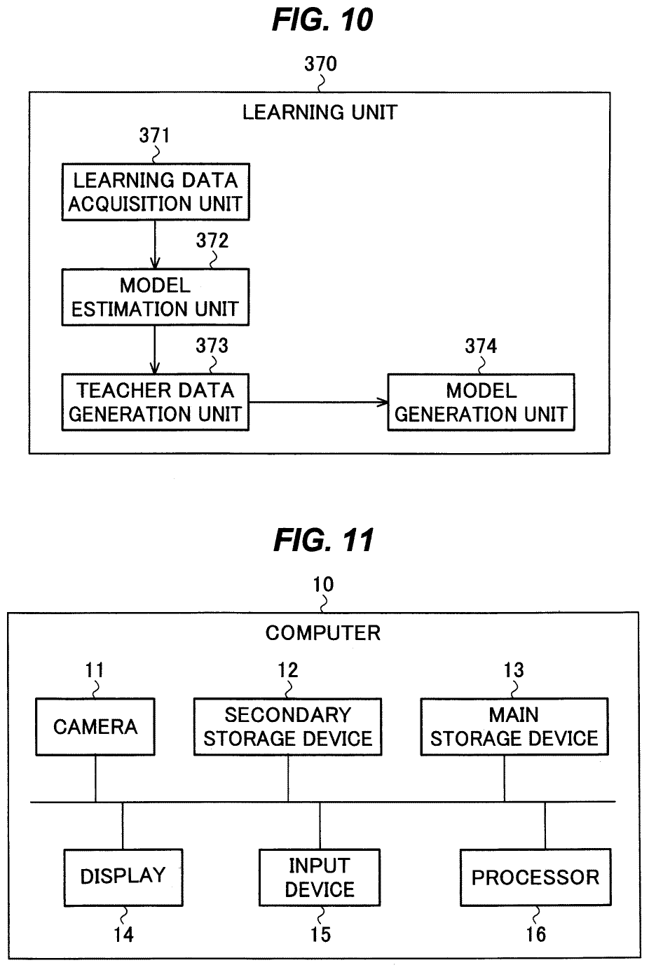

FIG. 10 is a block diagram schematically illustrating the configuration of the learning unit 370.

The learning unit 370 includes a learning data acquisition unit 371, a model estimation unit 372, a teacher data generation unit 373, and a model generation unit 374.

The learning data acquisition unit 371 acquires the second learning data from the second learning data storage unit 154 of the learning data generation and storage unit 150. The acquired second learning data is provided to the model estimation unit 372.

The model estimation unit 372 uses a high-precision AI estimation model to estimate the necessary information as annotation data for the second learning data. The model estimation unit 372 then provides the annotation data indicating the estimated information and the second learning data to the teacher data generation unit 373.

The teacher data generation unit 373 generates teacher data by attaching the annotation data from the model estimation unit 372 as correct answer labels to the second learning data. The generated teacher data is provided to the model generation unit 374.

The model generation unit 374 trains the learning model by using the teacher data from the teacher data generation unit 373.

As described above, according to Embodiment 3, it is possible to automatically generate teacher data from the second learning data and train a learning model by automatically estimating annotation data by using a high-precision AI model.

In addition, the model generation unit 374 may train the learning model by using “knowledge distillation”, a well-known technique that transfers knowledge of a high-precision AI estimation model to other models. The high-precision AI estimation model here may be the estimation model used in the model estimation unit 372.

In addition, the estimation model used in the estimation unit 131 can be updated by sending the weights of the learning model trained in the model generation unit 374 to the estimation unit 131 of the learning scene collection unit 130.

Each of the information processing devices 100, 200, and 300 described above can be implemented by a computer 10 as illustrated in FIG. 11, for example.

The computer 10 is equipped with a camera 11, a secondary storage device 12 such as a hard disk drive (HDD) or a solid state drive (SSD), a main storage device 13 such as volatile or non-volatile memory, a display 14, an input device 15 such as a keyboard or a mouse, and a processor 16 such as a central processing unit (CPU)).

For example, the image-capturing unit 110 can be implemented by the camera 11.

The scene information storage unit 134, the first learning data storage unit 152, and the second learning data storage unit 154 can be implemented by the secondary storage device 12 or the main storage device 13.

The estimation unit 131, the selection condition specification unit 132, the scene information selection unit 133, the learning data generation unit 151, the learning data check unit 153, and the learning units 270 and 370 can be implemented by the processor executing programs read from the secondary storage device 12 into the main storage device 13. When performing processing, the processor 16 can use the display 14, which functions as a display unit, and the input device 15, which functions as an input unit, as appropriate.

The functions executed by each of the information processing devices 100, 200, and 300 do not necessarily need to be implemented on a single computer 10 and can be implemented on multiple computers connected to a network such as the Internet, and configured as an information processing system. In this case, the computers are equipped with communication interfaces such as Network Interface Cards (NICs) that function as communication units, in addition to the configuration illustrated in FIG. 11. In this case, the multiple computers only need to send and receive the information and programs necessary for processing as appropriate.

Specifically, each of the image-capturing unit 110, the learning scene collection unit 130, the learning data generation and storage unit 150, and the learning units 270, 370 may be implemented on a single computer, or any combination of the image-capturing unit 110, the learning scene collection unit 130, the learning data generation and storage unit 150, and the learning units 270, 370 may be implemented on a single computer.

In the above-described Embodiments 2 and 3, the learning unit 270 and 370 generate teacher data, but Embodiments 2 and 3 are not limited to such examples. For example, when the learning data generation unit 151 creates the first learning data, it is possible to use the first learning data stored as the second learning data as the teacher data without modification by attaching necessary information as the correct answer label to the first learning data, such as the position information at which an object that does not present a privacy issue is superimposed on the background image and the type of the object that does not present a privacy issue.

### DESCRIPTION OF REFERENCE CHARACTERS

100, 200, 300 information processing device, 110 image-capturing unit, 130 learning scene collection unit, 131 estimation unit, 132 selection condition specification unit, 133 scene information selection unit, 134 scene information storage unit, 150 learning data generation and storage unit, 151 learning data generation unit, 152 first learning data storage unit, 153 learning data check unit, 154 second learning data storage unit, 270, 370 learning unit, 371 learning data acquisition unit, 372 model estimation unit, 373 teacher data generation unit, 374 model generation unit

1. An information processing device, comprising:
processing circuitry
to detect an object from an image represented by image data by using an estimation model and to estimate object-related information that is information related to the object; and
to select object-related information that satisfies a selection condition, from the estimated object-related information, as at least part of scene information.

2. The information processing device according to claim 1, wherein the selection condition is a condition to select the object-related information by using at least one of position, class name, and confidence level.

3. The information processing device according to claim 1, wherein the scene information includes, in addition to the object-related information, at least one of the hue of the object, the time when the image was captured, and the illuminance of the image.

4. The information processing device according to claim 1, wherein
the processing circuitry generates learning data that represents a new image according to the scene information; and
the processing circuitry checks whether the learning data is desirable data, and uses the learning data that is the desirable data as input data of teacher data to train a learning model.

5. The information processing device according to claim 4, wherein
the processing circuitry checks whether the estimation result estimated from the new image by using the estimation model satisfies the selection condition, and uses the learning data that satisfies the selection condition as input data.

6. The information processing device according to claim 4, wherein
the processing circuitry checks whether the estimation result obtained by estimating from the new image by using the estimation model satisfies the selection condition, and when the selection condition is satisfied, checks whether the estimation result estimated from the new image by using the estimation model is close to the scene information used when the learning data has been generated, and uses, as the input data, the learning data that is close to the scene information used when the learning data has been generated.

7. The information processing device according to claim 4, wherein
the processing circuitry generates the learning data by placing an object that does not present a privacy issue in the background image according to the scene information.

8. The information processing device according to claim 4, further comprising:
a display to display an example of how to capture a new image according to the scene information, wherein
the processing circuitry the learning data according to the example by using an image created by capturing an object that does not present a privacy issue.

9. The information processing device according to claim 4, wherein
when it is determined that the learning data is not the desirable data, the processing circuitry generates regenerated learning data that represents an image different from the new image according to the scene information, and
the processing circuitry checks whether the regenerated learning data is the desirable data, and uses the regenerated learning data that is the desirable data as the input data.

10. The information processing device according to claim 4, wherein
the processing circuitry trains the learning model by using the teacher data generated by attaching a correct answer label to the input data.

11. (canceled)

12. An information processing system, comprising:
processing circuitry
to detect an object from an image represented by image data by using an estimation model and to estimate object-related information that is information related to the object; and
to select object-related information that satisfies a selection condition, from the estimated object-related information, as at least part of scene information.

13. An information processing method, comprising:
detecting an object from an image represented by image data by using an estimation model and estimating object-related information that is information related to the object; and
selecting object-related information that satisfies a selection condition, from the estimated object-related information, as at least part of scene information.
